(19) United States
(12) Patent Application Publication
(10) Pub. No.: US 2003/0126963 A1
(43) Pub. Date: Jul. 10, 2003

(54) Die cutter monitoring system

(76) Inventors: Denny E. Davis II, Covington, VA (US); Edward A. Weller, Westminster, MD (US)

Correspondence Address: Donald L. Bowman, MeadWestvaco Corporation, 11101 Johns Hopkins Road, Laurel, MD, 20723, US

(21) Appl. No.: 10/370,871

(22) Filed: Feb. 20, 2003

Related U.S. Application Data
(63) Continuation-in-part of application No. 09/593,538, filed on Jun. 14, 2000, now Pat. No. 6,550,361.

(51) Int. Cl. B26D 1/00

(52) U.S. Cl. 83/13

(57) ABSTRACT

The invention is directed to a die cutter monitoring system. In an exemplary embodiment the system includes a frame that supports a die. A counter plate is located opposite and aligned with the die. A substrate is placed between the counter plate and die. The counter plate forces the substrate into contact with the die. A force measuring device measures the force of the cutting stroke. The force measuring device generates an output signal. The output signal is analyzed relative to acceptable conditions and operating parameters. If the die cutter is operating outside of acceptable limits, an adjustment signal is generated and sent to the die cutter control system or operator.

### CROSS-RELATED APPLICATION

This application is cross related to U.S. application Ser. No. 09/593,538 filed on Jun. 14, 2001 and issued as U.S. Pat. No. ______ on ______ 2003.

### FIELD OF THE INVENTION

The invention relates to a method and system of monitoring a die cutter.

### DESCRIPTION OF RELATED ART

It is well known to use a die cutter to cut substrates such as paper and paperboard. Platen die cutters and flat bed die-cutters are two common names for die cutters. A die cutter typically comprises an arrangement of cutting and scoring elements arranged to form a die. A conventional die cutter uses a counter plate to force a substrate into the die. It is well known that in die cutting operations, the die's cutting ability decreases with use. The cutting surface of the die typically dulls reducing cutting effectiveness. At some point the die will produce inaccurate, incomplete or partial cuts in the substrate, unless adjustments are made. A conventional method of monitoring the operation of a conventional die cutter is to visually inspect samples of the substrate after the cut is made. Typically, if inaccurate, incomplete or partial cuts are observed either the die is replaced, sharpened or additional force is applied to the counter plate. Applying additional force to the counter plate often temporarily improves the effectiveness of a dull die. Typically the force applied to the counter plate is controlled by what is commonly referred to as a tonnage gauge.

It is known to monitor the maximum force of a cutting stroke. For example, strain gauges have been used to show the relative maximum force of a cutting stroke. However, at least one shortcoming of this technique is that only the maximum cutting force is monitored. What is needed is a method to measure force during the cutting stroke and a means to detect and analyze changes in force over time. Furthermore, it is desirable to determine that adjustments to the die cutter are needed prior to cutting failures. Therefore there exists a need in the art for an improved die cutter monitoring system.

### SUMMARY OF THE INVENTION

The invention is directed to a die cutter monitoring system. In an exemplary embodiment the system includes a frame that supports a die. A counter plate is located opposite and aligned with the die. A substrate is placed between the counter plate and die. The counter plate forces the substrate into contact with the die. A force measuring device measures the force of the cutting stroke. The force measuring device generates an output signal. The output signal is further analyzed relative to acceptable conditions and operating parameters. If the die cutter is operating outside of acceptable limits, an adjustment signal is generated and sent to the die cutter control system or operator. The above and other features of the invention will become more apparent as the description proceeds and are best understood by following the detailed description of the invention in conjunction with the figures.

### BRIEF DESCRIPTION OF THE FIGURES

FIG. 1 is a side elevation view of a die cutter monitoring system according to the invention.

FIG. 2 is an end elevation view of the system of FIG. 1.

FIG. 3 is a side elevation view of the system of FIG. 1 during a cutting stroke.

FIG. 4 is a graphical illustration of the force curve during a typical cutting stroke.

FIG. 5 is a graphical illustration of the force curve during a typical cutting stroke just prior to operational failure.

FIG. 6 is a schematic illustration of an exemplary force output signal analysis system according to the invention.

### DETAILED DESCRIPTION OF THE INVENTION

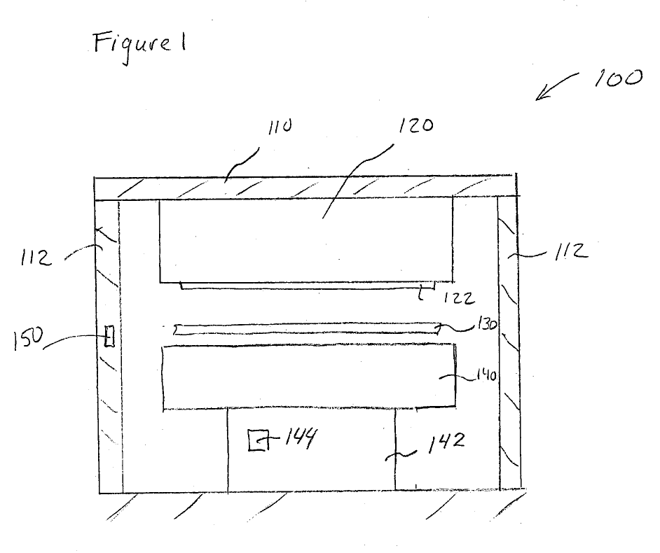

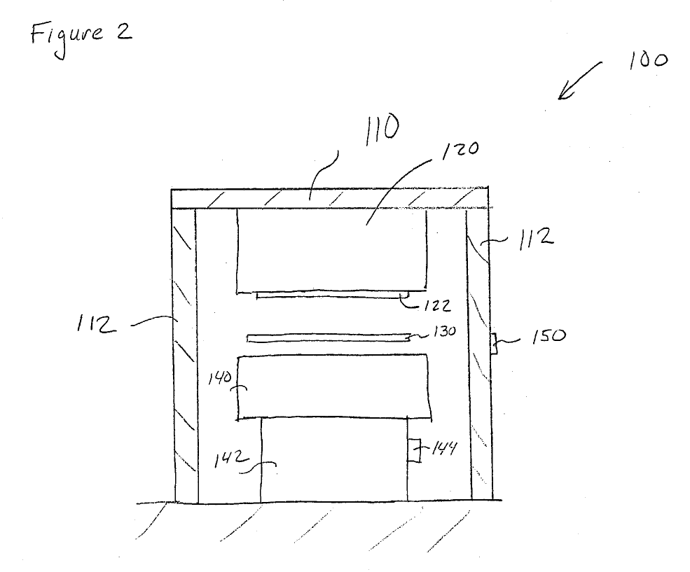

FIGS. 1 and 2 illustrate an exemplary die cutter monitoring system 100 according to the invention. The die cutter monitoring system is exemplary illustrated with a stationary die 122 and moveable counter plate 140. It is to be understood that either the die 122, counter plate 140, or both could be moveable. The die 122 is exemplary illustrated secured to horizontal frame 110 member via a die mount 120. The horizontal frame member 110 is secured to vertical frame members 112. It is to be understood that die 122 could be any conventional die, including a cutting die or a combination scoring and cutting die arranged in numerous configurations. An exemplary substrate 130, such as but not limited to paper, plastic, metal or paperboard, is illustrated located between the counter plate 140 and die 122. The large gaps between the substrate 130 and the counter plate 140 and die 122 are exaggerated for illustration purposes. It is to be understood that any suitable spacing or configuration is within the scope of the invention. The counter plate 140 is exemplary illustrated supported by a counter plate support 142.

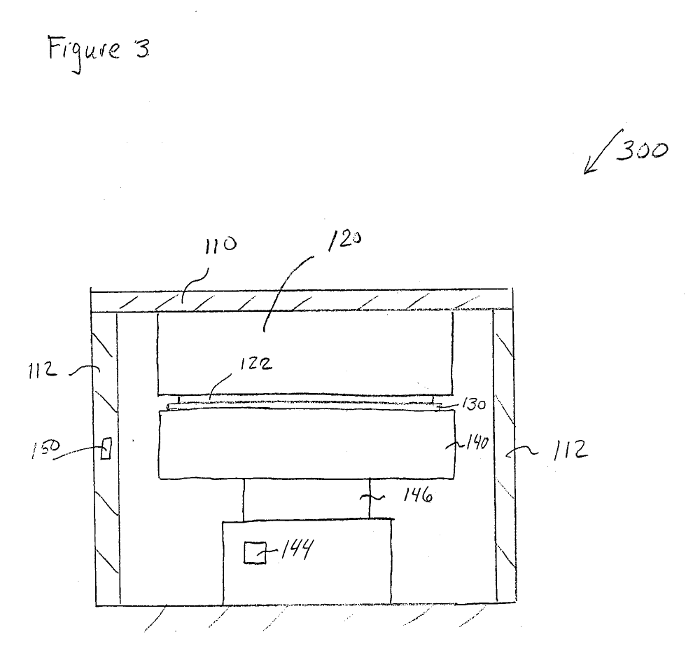

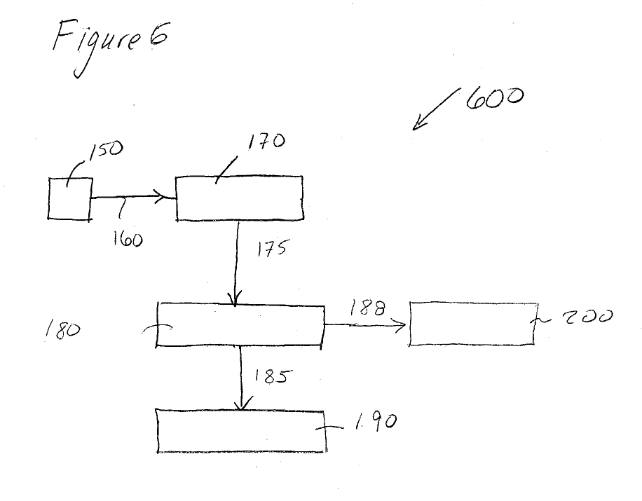

The counter plate 140 is exemplary illustrated with a movement control system 144, commonly referred to as a tonnage gauge. It is to be understood that any suitable means for moving and controlling either the counter plate 140, die 122, or both are within the scope of the invention. It is to be understood that the control system 144 could also include features to set up the die cutter 100 for an initial cut, help establish an initial cut force and establish ideal cutting forces upon reaching operating conditions. A force monitoring system 150 is exemplary illustrated on vertical support member 112. It is to be understood that force monitoring system 150 can be any suitable force monitoring means to include, but not limited to, a Wheatstone bridge or a piezo-ceramic monitoring device. It is to be understood that more than one force monitoring system 150 could be employed and that the location of the system 150 could be varied as well to include being located on any non-frame part of the system 100 or on the substrate 130. In an exemplary embodiment force monitoring system 150 measures the force transferred to the frame members 110, 112 during the cutting stroke (illustrated in FIG. 3). The force monitoring system 150 generates an output signal analysis system 160 (not shown) that is discussed below in relationship to FIG. 6.

FIG. 3 illustrates the exemplary die cutter monitoring system 100 during a cutting stroke 300. The counter plate 140 is exemplary illustrated as moved toward the die 122 by counter plate arm 146. During the cutting stroke, the substrate 130 is forced between the die 122 and counter plate 140 to cut or score (not shown) the substrate 130. The force monitoring system 150 measures the force throughout the cutting stroke cycle.

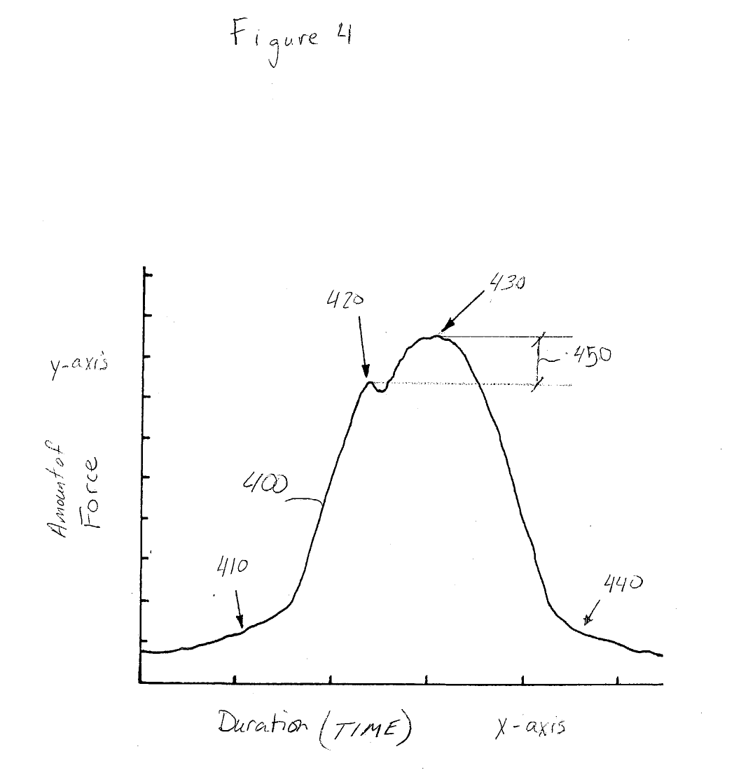

FIG. 4 graphically illustrates an exemplary force curve 400 from a cutting stroke during normal operations. The x-axis represents the duration (time) of the cutting stroke cycle. The y-axis represents the relative amount of force throughout the cutting stroke cycle. The stroke is initiated at approximately point 410 on the curve 400. The force 400 typically dips at point 420 as the substrate 130 bursts. The force 400 reaches a peak, illustrated as point 430, when the counter plate 140 and die 122 are substantially in contact with each other. The force curve 400 falls as the counter plate 140 moves away from the die 122 reaching approximately point 440 at the end of the cutting cycle. The force differential between points 420 and point 430, represented as line 450, is a useful means for monitoring the operation of the die cutter 100.

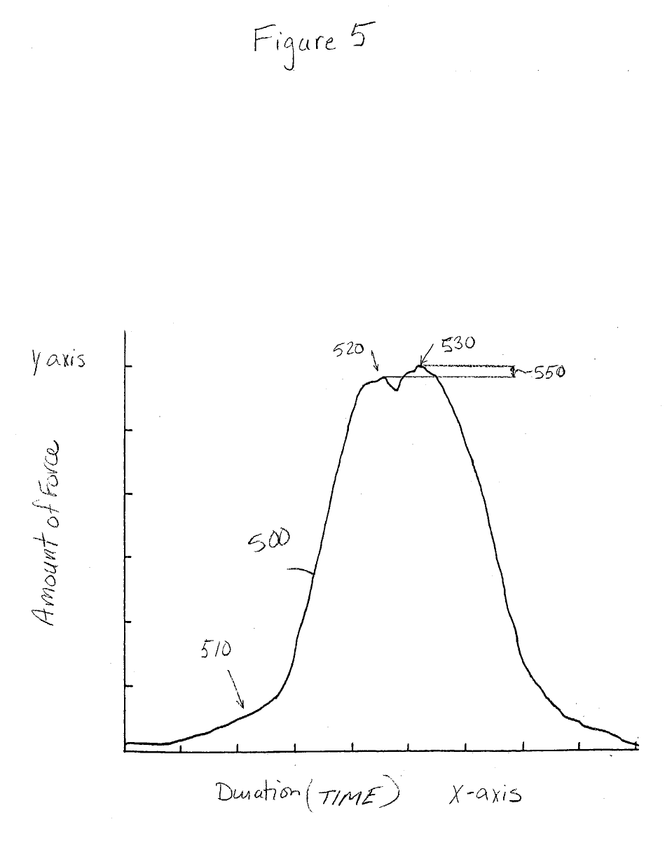

FIG. 5 graphically illustrates the force curve 500 during a cutting stroke cycle as the die cutter 100 nears operational failure. The failure could be caused from a dull die 122 or a combination of operational issues. The x-axis represents the duration (time) of the cutting stroke cycle. The y-axis represents the relative amount of force applied to the counter plate during the cutting stroke cycle. The difference between the maximum force 530 and the burst force 520 is much smaller near operational failure. The force differential between points 520 and 530 is represented as line 550. FIG. 5 illustrates the smaller force differential as cutting efficiency decreases, as compared to FIG. 4.

FIG. 6 schematically illustrates an exemplary embodiment of an output signal analysis system 600. The system exemplary illustrates one means to analyze the output signal 160 from the force monitoring system 150 of FIG. 1. It is to be understood that numerous hardware configurations could be utilized. It is to be understood that the output signal 160 could be analyzed using numerous well-known techniques. An exemplary system 600 will transmit the digital or analog output signal 160 to an optional converter 170 (for example: an amplifier, filter, Analog to Digital converter, etc) that transforms as appropriate the output signal 160 into a conditioned signal 175. The conditioned signal 175 is transmitted to an analyzing device 180, such as a digital computer. For example device 180 could identify the cut stroke maximum force, the burst force, and the difference between the two forces, etc. Ideally, the analyzer device 180 could be programmed with a variety of die cutter operating parameters, such as the acceptable maximum force, acceptable force operating ranges, historical die cutter operating conditions, various databases and features to compare conditioned signal 175 to acceptable operating standards, etc.

In an exemplary system, the analyzing device 180 generates one or more output signals 185, 188. A first exemplary output signal 185 is generated to a die cutter control system 190. For example, the control system could exemplary control the cutter 100 electronically, pneumatically, or by other suitable means to control or adjust the operation of a die cutter 100. A second exemplary output device 200 could include a visual or audio means to signal the die cutter operator (not shown) to adjust the die cutter. Other exemplary output devices (not shown) could include a means to communicate that the operation is operating within acceptable parameters and predict the time or number or cuts until cutting failure occurs. Moreover, an output signal could generate suggested adjustments to the die cutter 100 operation based on analysis of the output signal 160 and past operating history. For example, if the difference between the maximum force and the substrate burst force approaches an unacceptable minimum, the analyzing device 180 could provide proposed adjustments such as increasing the force applied to the counter plate 140.

Once given the above disclosure, many other features, modifications or improvements will become apparent to the skilled artisan. Such features, modifications or improvements are, therefore, considered to be a part of this invention, the scope of which is to be determined by the following claims.

1. A method comprising the steps of:
operating an apparatus comprising a die, a counter plate, a movement means to align and move said die and said counter plate, a substrate located at least partially between said die and counter plate, and a force measurement device in communication with said apparatus so that said die, said substrate, and said counter plate are substantially in contact with each other;
measuring the force during said operation by said force measuring device; and
generating an output signal from said force measurement device.

2. The method of claim 1 wherein said force measurement devices comprises a strain measurement device.

3. The method of claim 2 wherein said strain measurement device comprises a Wheatstone bridge.

4. The method of claim 1 wherein said output signal comprises an electrical voltage.

5. The method of claim 1 wherein said force measurement device comprises a piezo ceramic device.

6. The method of claim 1 wherein said output signal comprises an electrical current.

7. The method of claim 1 further comprising a device to convert said output signal.

8. The method of claim 1 further comprising an output signal analyzing device in communication with said force measuring device wherein said analyzing device generates an output.

9. The method of claim 8 further comprising at least one output device in communication with said analyzing device.

10. The method of claim 8 wherein said analyzing device is programmable.

11. The method of claim 8 wherein said analyzing device compares said output signal to known operating conditions.

12. The method of claim 11 further comprising the step of generating an output signal when said apparatus is operating outside of acceptable known operating conditions.

13. The method of claim 11 further comprising the step of determining the difference between the maximum force and the substrate burst force.
